(19) United States
(12) Patent Application Publication
(10) Pub. No.: US 2024/0176941 A1
(43) Pub. Date: May 30, 2024

(54) PRINTED CIRCUIT BOARD PIN FIELD SIGNAL ROUTING

(71) Applicant: Intel Corporation, Santa Clara, CA (US)

(72) Inventors: Xiaoning Ye, Portland, OR (US); Jorge A. Alvarez, Zapopan (MX); Jose de Jesus Jauregui Ruelas, Guadalajara (MX); Vijaya K. Kunda, Portland, OR (US); Hong-Yi Luoh, Portland, OR (US); Yanwu Wang, Suzhou (CN); Chunfei Ye, Lacey, WA (US)

(73) Assignee: Intel Corporation, Santa Clara, CA (US)

(21) Appl. No.: 18/552,213

(22) PCT Filed: Jun. 23, 2021
(86) PCT No.: PCT/CN2021/101806

§ 371 Date: Sep. 25, 2023

(51) Int. Cl. G06F 30/3953; G06F 30/392; G06F 30/398; G06F 119/10

(52) U.S. Cl. CPC G06F 30/3953; G06F 30/392; G06F 30/398; G06F 2119/10

(57) ABSTRACT

Signal lines in the pin field of a printed circuit board layout are modified to reduce line impedance and improve signal integrity. The widths of signal lines are extended in the pin field to take full advantage of the available routing space between pads and adjacent signal lines. The signal line extension can be considered a subtractive approach in that the signal lines are extended to occupy the available muting space, with signal line extensions that would otherwise cause design rule violations being subtracted out. The edge of a signal line is extended to a keep-out region associated with a centerline that extends through a plurality of pads arranged in a line and located adjacent to the signal line. The edge of the signal line is also extended to keep-out regions associated with pads in the pin fields.

### BACKGROUND

The tight pin pitch in modern high-performance processors limits the available area for muting signals through the pin field on the printed circuit board. The width and spacing of signal lines muted through a pin field can be narrower than that of signal lines routed outside of the pin field of a printed circuit board. Due to their narrower line width, pin field signal lines have a higher impedance and suffer from signal integrity degradation.

### BRIEF DESCRIPTION OF THE DRAWINGS

FIG. 1 illustrates example signal line muting in a pin field of a printed circuit board layout.

FIG. 2 illustrates example signal lines with tab routing in a pin field of a printed circuit board layout.

FIG. 3A illustrates a pin field layout portion comprising signal lines prior to modification.

FIG. 3B illustrates the pin field layout portion of FIG. 3A after signal line modification.

FIG. 3C illustrates an example signal line modification bounded by a pin field boundary.

FIG. 3D illustrates an example signal line modification bounded by pad centerlines.

FIG. 4 is a cross-sectional view of a back-side drilled printed circuit board via.

FIG. 5 illustrates an example modification of a signal line adjacent to a plurality of vias.

FIG. 6 illustrates a printed circuit board layout portion comprising modified signal lines.

FIG. 7 is a block diagram of an example computing system that can automatically modify signal lines in printed circuit board layouts.

FIG. 8 is a flowchart of a first example method of modifying signal lines in a pin field of a printed circuit board layout.

FIG. 9 is a flowchart of a second example method of modifying signal lines in a pin field of a printed circuit board layout.

FIG. 10 is a block diagram of an example computing system in which technologies described herein may be implemented.

FIG. 11 is a block diagram of an exemplary processor unit that can execute instructions as part of implementing technologies described herein.

FIG. 12 is a cross-sectional side view of an integrated circuit device assembly that may include a printed circuit board manufactured based on a printed circuit board layout modified as disclosed herein.

### DETAILED DESCRIPTION

The number of pins in high-performance processors (e.g., server CPUs) has increased in successive processor product generations as the demand for high I/O bandwidth has increased over time. Processor pin pitch (the distance between adjacent pins) has shrunk over time to prevent integrated circuit component package sizes from scaling at the same rate as socket pin count. In some existing server processors, the pin pitch has shrunk from 39 mil to 37 mil, and is expected to shrink even further, for example, to 35 mil, in the next few years. Reduced pin pitch creates signal integrity challenges for signals routed through the pin field of a printed circuit board.

As used herein, the term “integrated circuit component” refers to a packaged or unpacked integrated circuit product. A packaged integrated circuit component comprises one or more integrated circuits mounted on a package substrate. In one example, a packaged integrated circuit component contains one or more processor units mounted on a substrate, with an exterior surface of the substrate comprising a solder ball grid array (BGA) or a land grid array (LGA). In one example of an unpackaged integrated circuit component, a single monolithic integrated circuit die comprises solder bumps attached to contacts on the die. The solder bumps allow the die to be directly attached to a printed circuit board. An integrated circuit component can comprise one or more of any computing system component described or referenced herein or any other computing system component, such as a processor unit (e.g., system-on-a-chip (SoC), processor core, graphics processor unit (GPU), accelerator), I/O controller, chipset processor, memory, or network interface controller.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the software or firmware instructions are not actively being executed by the system, device, platform, or resource.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, a signal line described as substantially filling an area may not completely fill the area due to, for example, electronic design automation (EDA) tool limitations. For example, the resolution of a grid to which vertices of shapes in an EDA layout tool attach may be coarse enough to prevent a signal line from being extended to completely fill the specified area. Further, an edge of layout shape referred to as substantially identical to another shape may not be exactly identical due to, for example, again, layout tool grid resolution constraints.

Reference is now made to the drawings, which are not necessarily drawn to scale, wherein similar or same numbers may be used to designate same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

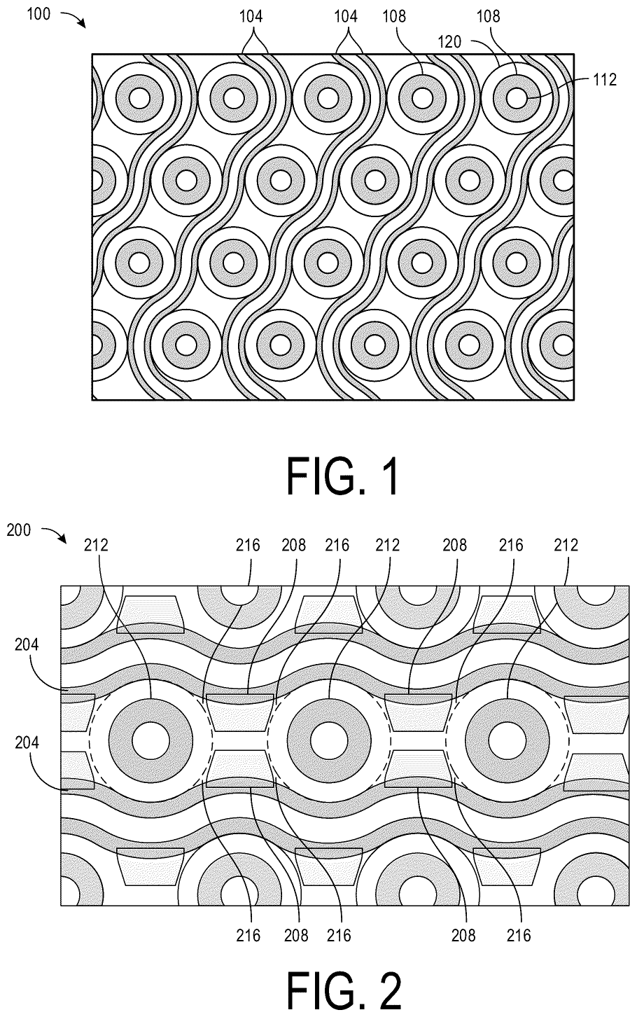

FIG. 1 illustrates example signal line routing in a pin field of a printed circuit board layout. The region 100 comprises pairs of conductive traces (or signal lines) 104 routed between pads 108 in a pin field, with individual pads 108 having an associated via 112 and keep-out region 120. The pin field is a region of a printed circuit board layout comprising pads to which packaged integrated circuit component pins are to connect. The keep-out regions 120 can be based on a design rule, such as a design for manufacturing (DFM) rule or design rule check (DRC) rule developed to reduce manufacturing defects caused by an insufficient distance between a signal line 104 and a pad 108 or a signal line 104 and a via 112.

Design rule requirements and a tight pin pitch can result in signal line widths in the pin field being less than that in layout regions outside of the pin field (open areas, open fields). For example, the portion of a signal line routed through a pin field can have a width of 3.5 mil and a portion of the same signal line routed through an open area can have a width of 5-6 mil. The higher impedance and increased loss of pin field signal lines due to smaller line width can result in signal integrity degradation. Simulation results for an example printed circuit board layout indicate that the narrower widths of pin field signal lines can result in a greater than 10 mV reduction in receiver-side eye margin in double data rate (DDR) memory signals. Greater eye margin reductions are expected as pin field signal line widths are expected to narrow further (e.g., 3 mil) in future product generations.

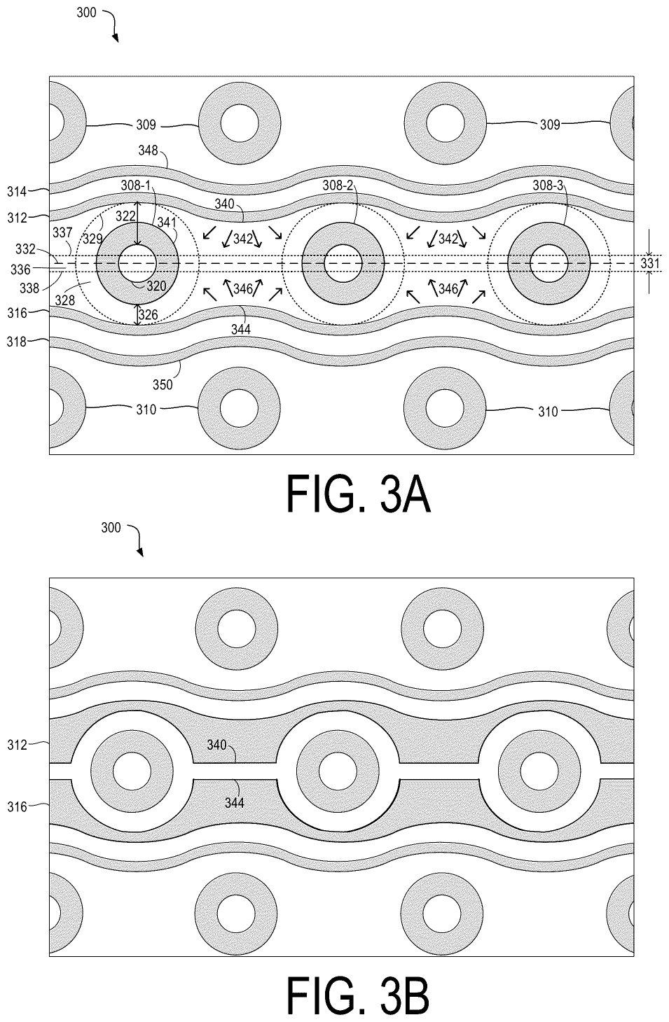

FIG. 2 illustrates example signal lines with tab routing in a pin field of a printed circuit board layout. The pin field layout region portion 200 comprises signal lines 204 that comprise trapezoidal tabs 208 that have been added to the signal lines 204 to improve signal integrity. Pads 212 are located between the signal lines 204 and the tabs 208 occupy a portion of the area between the signal lines 204 and adjacent pads 212. The addition of the tabs 208 lowers the impedance of the signal lines 204 and thereby improves their signal integrity. While the addition of the tabs 208 improves signal integrity, tab routing can suffer from disadvantages. First, tab routing may lead to complexity in the printed circuit board physical design process. For example, a large number of tab geometries may need to be added to the layout if a large number of signal lines are routed through a pin field. Even if automated approaches are developed for tab placement, engineering resources will still likely be needed to develop the automated approach and physical designer resources may still be needed to fix any DFM (design for manufacturing) or DRC (design rule check) rule violations created by the automated addition of the tabs. Second, tab routing may not take full advantage of the available layout area for expanding signal line widths and thus may not reduce signal line impedance by the fullest amount possible. For example, the addition of the tabs 208 to the signal lines 204 leaves available layout areas 216 unused.

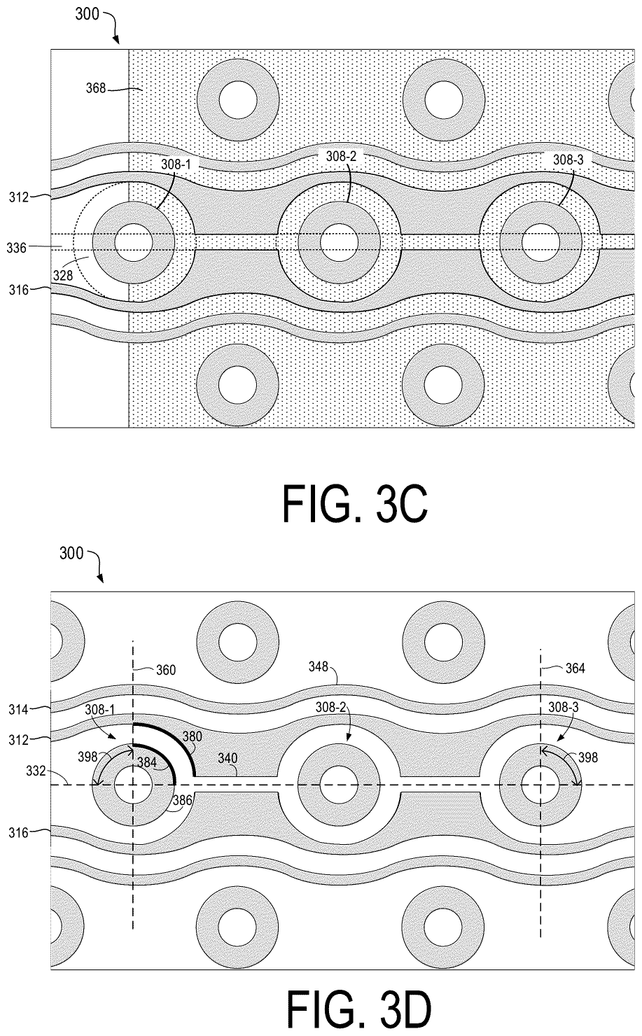

FIGS. 3A & 3B illustrate an example modification of pin field signal lines utilizing the technologies disclosed herein. FIG. 3A illustrates a pin field layout portion comprising signal lines prior to modification. The pin field layout portion 300 comprises pads 308 (e.g., 308-1, 308-2, 308-3), 309, and 310 and signal lines 312 and 316 on a front side of a printed circuit board. The pads 308 are located between the signal lines 312 and 316.

Individual pads 308 have an associated via 320 that connect the individual pad 308 to one or more other interconnect layers (e.g., internal interconnect layer, back side interconnects) of the printed circuit board layouts. Pads 308 have associated keep-out regions 328 that signal lines are to be excluded from. A keep-out region 328 has an associated outer edge 329. The extent of the keep-out region 328 can be based on a design rule distance. For example, the extent of a keep-out region 328 can be based on a via-to-metal (drill-to-metal, drill-to-trace) design rule spacing 322 to ensure sufficient spacing between a pad and a signal line or a metal-to-metal (trace-to-trace) design rule spacing 326 to ensure sufficient spacing between a pad and a signal line. The via-to-metal spacing 322 can be based on via holes drilled from the front side or the back side of a printed circuit board.

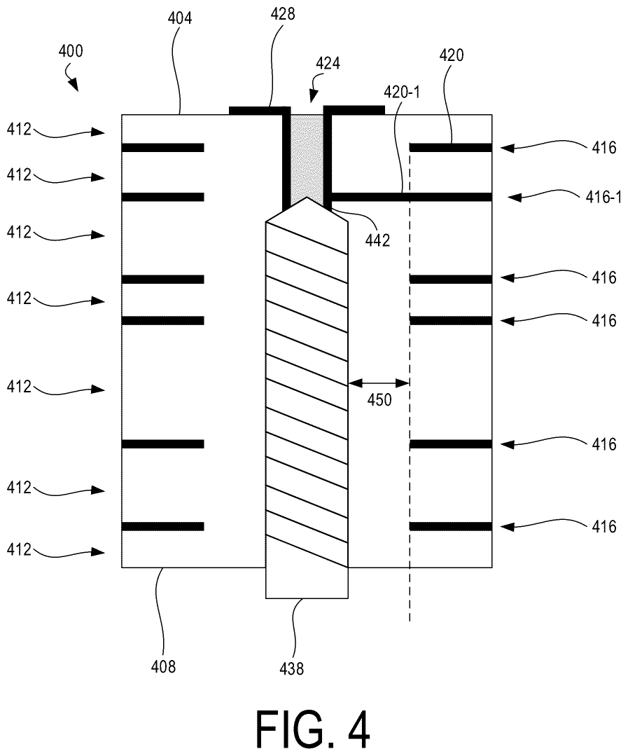

FIG. 4 is a cross-sectional view of a back-side drilled of a printed circuit board via. The printed circuit board 400 comprises a front side 404, a back side 408, dielectric layers 412 and interconnect layers 416. The individual interconnect layers comprise one or more conductive traces 420. The printed circuit board 400 further comprises a via 424 that provides an electrical connection from a pad 428 to a conductive trace 420-1 of interconnect layer 416-1. A drill bit 438 is used to drill into the via 424 from the back side 408 of the printed circuit board 400 to reduce the height of the via stub 442. Generally, reducing the height of via stubs reduces the amount of signal distortion suffered by a signal transmitted through the via. Dimension 450 represents a via-to-metal (drill-to-metal, drill-to-trace) design rule spacing for back-side drilled vias. The via-to-metal design rule spacing for a back-side drilled via (e.g., dimension 450) can be different from the via-to-metal design rule spacing for a front-side drilled via.

Returning to FIG. 3A, the plurality of pads 308 extends in a line from a first pad 308-1 to a second pad 308-3. A centerline 332 extends through the plurality of pads 308 and a keep-out region 336 extends along and is centered about the centerline 332. The keep-out region 336 has an edge 337 that is proximate to the signal line 312 and an edge 338 that is proximate to the signal line 316. The extent of the keep-out region 336 can be based on a design rule, such as, for example, a metal-to-metal spacing 331 to ensure sufficient spacing between signal lines. In some embodiments, the extent of the keep-out regions 328 and 336 can be based on a metal-to-metal spacing performance-based design rule to ensure a certain level of signal performance. For example, increasing the minimum spacing between adjacent signal lines can reduce the amount of capacitive coupling between the signals. The metal-to-metal spacing of a performance-based design rule can be greater than a metal-to-metal spacing of a manufacturing-based design rule (e.g., DFM rule).

The signal line 312 is modified by extending an edge 340 of the signal line 312 that is proximate to the pads 308 to the edge 337 of the keep-out region 336 and to the edges 329 of the keep-out regions 328. The signal line 316 is modified by extending an edge 344 of the signal line 316 that is proximate to the pads 308 to the edge 338 of the keep-out regions 336 and to the edges 329 of the keep-out regions 328. Arrows 342 and 346 indicate the direction that the edges 340 and 344, respectively, are extended.

FIG. 3B illustrates the pin field layout portion of FIG. 3A after signal line modification. The edges 340 and 344 of the signal lines 312 and 316, respectively, have been extended to the edges of keep-out regions 328 and 336. As a result of the modification, the signal lines 312 and 316 occupy the full area between the signal lines 312 and 316 before modification and the pads 308, subject to design rule constraints. The modified signal lines 312 and 316 illustrated in FIG. 3B have lower impedance and provide improved signal integrity relative to the signal lines 312 and 316 before modification. Signal lines 314 and 318 can be modified in a similar fashion. An edge 348 of the signal line 314 can be extended toward keep-out regions (not shown) associated with the pads 309 similar to the keep-out regions associated with the pads 308 and a centerline that extends through the pads 309, and an edge 350 of the signal line 318 can be extended toward keep-out regions (not shown) associated with the pads 310 similar to the keep-out regions associated with the pads 308 and a centerline that extends through the pads 310.

Thus, while the tab routing approach to signal line modification can be considered to be an additive modification (trapezoidal tabs being added to the signal lines) the signal line modification technologies disclosed herein can be considered to be a subtractive modification in that the signal lines are extended to occupy the available layout area between the pre-modified signal lines and adjacent pads and other signal lines, with signal line extensions that would otherwise cause design rule violations being subtracted out. In some embodiments, the modification of signal lines 312 in FIG. 3B can be generated by extending the edge 340 of the signal line 312 to the centerline 332 and to the outer edges of the pads 308 (pad edges 341) and then pulling back the edge 340 such that the modified signal line 312 does not cause design rule violations. That is, the edge 340 is pulled back to the edge 337 of the keep-out region 336 and to the edges 329 of the keep-out regions 328. Put another way, the signal line 312 is modified by extending the edge 340 past the edge 337 of the keep-out region 336 and past the edges 329 of the keep-out regions 328 and then pulling the edge 340 back to the edges 337 and 329 of the keep-out regions 336 and 328 respectively.

Although the signal lines 312 and 316 are shown as being modified with respect to three pads 308 arranged in a line, signal lines can be modified with respect to any number of pads adjacent to a signal line. Further, although the modified signal lines 312 and 316 are located on a front side of a printed circuit board, signal lines located on interconnect layers internal to the printed circuit board or on the back side of a printed circuit board can be similarly modified. Signal lines on an internal interconnect layer can be modified to extend to keep-out regions associated with a centerline extending through a plurality of vias arranged in a line at the internal interconnect layer and keep-out regions associated with the individual vias.

In some embodiments, signal lines with pads located between them (e.g., signal lines 312, 316) can be modified without reference to a keep-out region associated with a centerline the extends through a plurality of pads arranged in a line (e.g., centerline 332). For example, the signal lines 312 and 316 can be modified by incrementally extending the edges 340 and 344 toward each other until they are within a metal-to-metal design rule (which, as previously discussed, can be DFM-based or performance-based) spacing of each other. Thus, if the signal lines 312 and 316 are not equally spaced from the pads 308, the overall amount that the edges 340 and 344 are extended may be unequal. In some embodiments, the metal-to-metal distance can be based on a signal integrity performance requirement. For example, a metal-to-metal distance can be used that results in the characteristic impedance of a modified signal line in the pin field region matching that of the signal line outside of pin field. In some embodiments, a metal-to-metal spacing that provides impedance matching between pin field and open area portions of a signal line can be automatically determined by an EDA tool or other suitable application. The EDA tool can determine an impedance of an open area portion of a signal line that a pin field portion of the signal line is to match to, and determine a metal-to-metal spacing that will result in a modified pin field portion of the signal line having a characteristic impedance that matches that of the open area portion of the signal line. An EDA tool can automatically determine the metal-to-metal spacing that results in impedance matching as part of automatically modifying pin field signal lines or before the signal line modification process. The determined metal-to-metal spacing for impedance matching can be different for different signal lines in the pin field.

In some embodiments, the layout region within which signal lines are modified can be defined by boundaries in addition to the keep-out regions already discussed, such as a pin field boundary or boundaries associated with individual pads. FIG. 3C illustrates an example signal line modification bounded by a pin field boundary. In FIG. 3C, modification of the signal lines 312 and 316 is bounded by a pin field 368 in addition to the keep-out regions 328 and 336. The modification of the signal lines 312 and 316 is constrained to the pin field 368. The pin field 368 can be generated in the printed circuit board layout through, for example, manual addition by a physical designer. In other embodiments, the extent of the pin field can be automatically determined during pin field signal line modification by an electronic design automation (EDA) tool based on, for example, a pad density. For example, a pin field can be automatically identified during pin field signal line modification as a layout region within which a pad density exceeds a pad density threshold. The pad density threshold can be indicative of a pad density associated with a pin pitch for a particular device.

FIG. 3D illustrates an example signal line modification bounded by pad centerlines. In FIG. 3D, modification of the signal lines 312 and 316 is bounded by a centerline 360 of the first pad 308-1 and centerline 364 of the second pad 308-3. The centerlines 360 and 364 are orthogonal to the centerline 332 that extends through the plurality of pads 308. In other embodiments, the centerlines 360 and 364 can be non-orthogonal to the centerline 332. For example, an angle 398 between the centerlines 360 and 364 can be any angle less than 90 degrees (e.g., 60 degrees, 45 degrees, 30 degrees).

In some embodiments, such as those illustrated in FIGS. 3B, 3C, and 3D, modified signal lines (as they appear in a printed circuit board layout or a manufactured printed circuit board) can be characterized with respect to a centerline extending through a plurality of pads located adjacent to the signal line and arranged in a line from a first pad to a second pad and second centerlines of the first and second pads. For example, with reference to FIG. 3D, the signal line 312 is adjacent to a plurality of pads 308 arranged in a line starting from the first pad 308-1 to the second pad 308-3, with the centerline 332 extending through the plurality of the pads 308. The signal line 312 substantially fills an area bounded by centerline 332, an edge 348 of the signal line that is a distal edge of the signal line relative to the centerline 332, the centerline 360 of the first pad 308-1, and the centerline 364 of the second pad 308-3, the centerlines 360 and 364 being orthogonal to the centerline 332. The signal line 312 substantially fills the area to an extent that it is spaced from the pads 308 and signal lines 314 and 316. That is, after modification, the signal line 312 remains a separate layout shape from the pads and the one or more additional signal lines. The signal line 312 further substantially fills the area to an extent that a shape of a portion of an edge of the modified signal line in the vicinity of an individual pad is substantially identical to a shape of a portion of an edge of the individual pad in the vicinity of the modified signal line. For example, a portion 380 of the edge 340 of the signal line 312 located in the vicinity of the pad 308-1 has a circular arc shape that is substantially identical to the circular arc shape of a portion 384 of an edge 386 of the pad 308-1 located in the vicinity of the portion 380 of the edge 340 of the signal line 312.

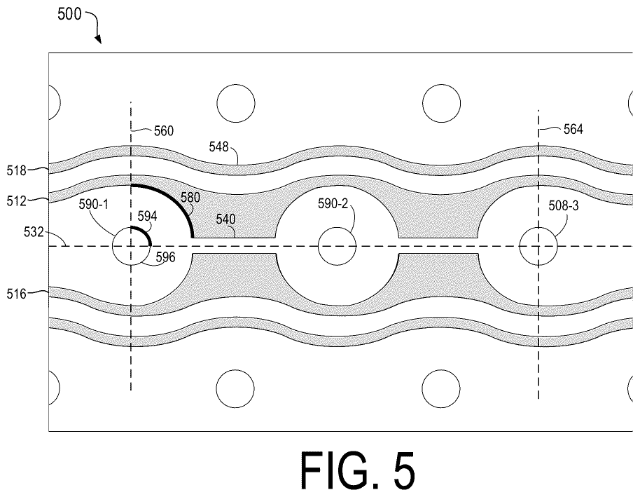

In some embodiments, a modified signal line can be characterized with respect to a centerline extending through a plurality of vias located adjacent to the signal line and arranged in a line from a first via to a second via and second centerlines of the first and second vias. FIG. 5 illustrates an example modification of a signal line adjacent to a plurality of vias. The layout portion 500 comprises a signal line 512 adjacent to a plurality of vias 590 (590-1, 590-2, 590-3) arranged in a line starting from a first via 590-1 to a second via 590-3 with a centerline 532 extending through the plurality of the vias 590 The layout portion 500 can be a portion of an internal interconnect layer within the pin field of a printed circuit board layout. The signal line 512 substantially fills an area bounded by the centerline 532, an edge 548 of the signal line 512 that is a distal edge from the centerline 532, a centerline 560 of the first via 590-1, and a centerline 564 of the second via 590-3. The centerlines 560 and 564 being orthogonal to the centerline 532. The signal line 512 substantially fills the area to an extent that it is spaced from the vias 590 and adjacent signal lines 516 and 518. That is, after modification, the signal line 512 remains a separate layout shape from the vias 590 and the adjacent signal lines 516 and 518. The signal line 512 further substantially fills the area to an extent that a shape of a portion of an edge of the signal line in the vicinity of an individual via is substantially identical to a shape of a portion of an edge of the individual via in the vicinity of the signal line. For example, a portion 580 of an edge 540 of the signal line 512 in the vicinity of the via 590-1 has a circular arc shape that is substantially identical to a circular arc shape of a portion 594 of an edge 596 of the via 590-1 located in the vicinity of the portion 580 of the edge 540 of the signal line 512.

Although the pads 308 in FIG. 3A are shown as being circular and being centered around via 320, signal lines can be modified in layouts where the adjacent pads are not circular (e.g., oblong, oval) and/or are not centered around a via. As an example of the latter, an oblong pad could enclose a via by a greater amount on one end of the oblong pad than on the opposing end of the oblong pad.

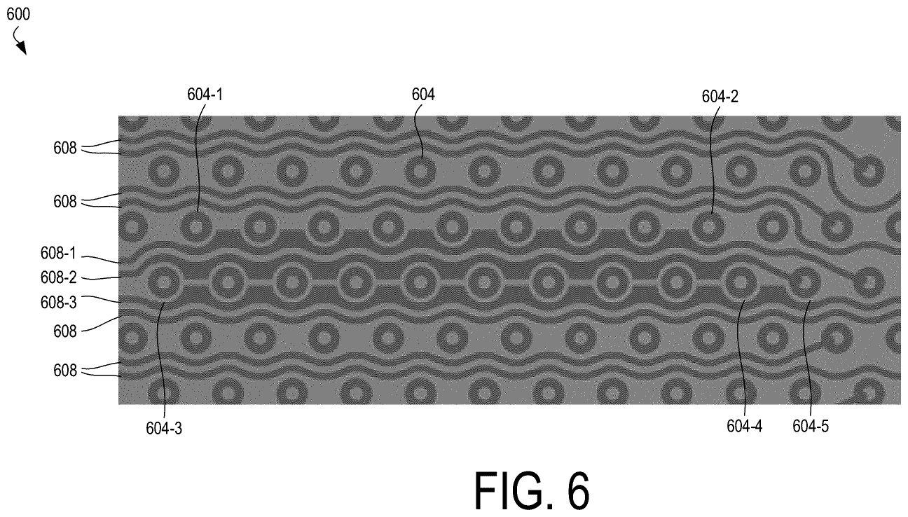

FIG. 6 illustrates a printed circuit board layout portion comprising modified signal lines. The layout portion 600 comprises pads 604 and signal lines 608 within a pin field of a printed circuit board layout. Signal lines 608-1, 608-2, and 608-3 have been modified utilizing technologies disclosed herein. The signal line 608-1 has been modified over a region extending from a first pad 604-1 to a second 604-2 and its width has been extended to within a keep-out distance from a pad centerline extending through a plurality of pads 604 from the first pad 604-1 to the second pad 604-2. The signal line 608-2 has been modified over a region extending from a first pad 604-3 to a second pad 604-4 and its width has been extended to within a keep-out distance from a pad centerline extending through a plurality of pads 604 from the first pad 604-3 to the second pad 604-4. The signal line 608-3 has been modified from a first pad 604-3 to a second 604-5 and its width has been extended to within a keep-out distance from a pad centerline extending through a plurality of pads 604 from the first pad 604-3 to the second pad 604-5.

In some embodiments, the signal lines modification approaches described herein can be performed automatically by electronic design automation (EDA) software or any other suitable application that can execute on a computing system. In some embodiments, signal line modifications can be performed by a script written using instructions that an EDA tool can interpret and execute. In some embodiments, a modified signal line can be represented as a single shape (or polygon) in the layout. Having a modified signal line represented as a single shape can avoid layout database efficiencies. For example, in the tab routing approach, if the added tabs are stored in the database as individual features, hundreds, if not thousands, of additional features may need to be stored in the layout database. Representing modified signal lines as a single feature can also result in fewer design rule violations and quicker design rule verification (DRC/DFM) runtimes.

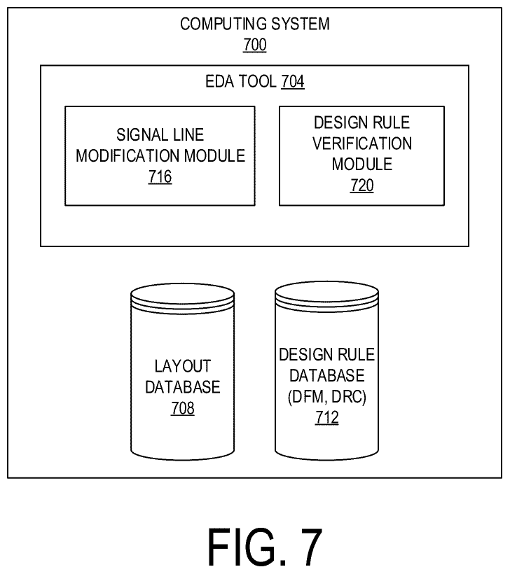

FIG. 7 is a block diagram of an example computing system that can automatically modify signal lines in printed circuit board layouts. The system 700 comprises an EDA tool 704, a layout database 708, and a design rule database 712. The layout database 708 can comprise one or more files, data structures, etc. that represent a printed circuit board layout and the layout can be represented hierarchically or non-hierarchically (“flat”) in the database 704. The design rule database 712 stores design rules that a printed circuit board layout is to adhere to provide reliable manufacturing of printed circuit boards at volume. The EDA tool 704 comprises a signal line modification module 716 that automatically performs signal line modification according to the technologies described herein and a design rule verification module 720 that can check a printed circuit board layout stored in the layout database 708 against design rules in the design rule database 712.

Printed circuit board layouts comprising signal lines that have been modified as described herein can be used to generate photolithography masks that are used during the manufacture of printed circuit boards. For example, a photolithography mask comprising modified signal lines can be used to pattern conductive traces on an interconnect layer of a printed circuit board. The interconnect layers of a printed circuit board can comprise copper or any other suitable conductive material. Printed circuit boards manufactured based on printed circuit board layouts comprising modified signal lines as described herein can have one or more integrated circuit components attached or connected to the printed circuit board and the printed circuit boards can be used in any type of electronic device, such as computing devices or computing systems.

It is to be understood that FIG. 7 illustrates one example of a set of modules that can be included in a computing device. In other embodiments, a computing device can have more or fewer modules than those shown in FIG. 7. Further, separate modules can be combined into a single module, and single module can be split into multiple modules. The modules shown in FIG. 7 can be implemented in software, hardware, firmware, or combinations thereof.

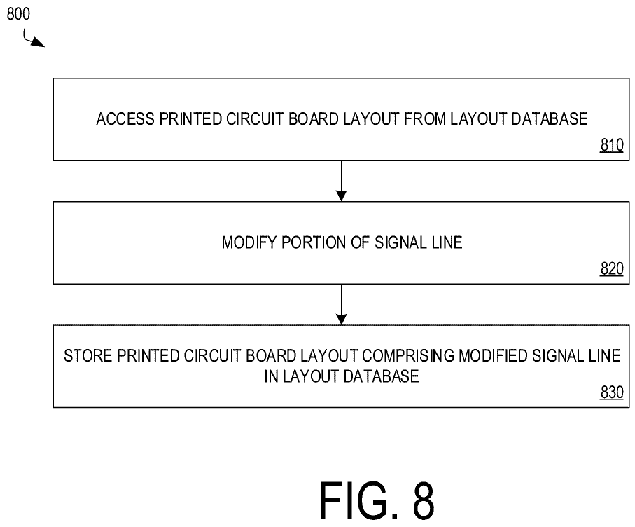

FIG. 8 is a flowchart of a first example method of modifying signal lines in a pin field of a printed circuit board layout. The method 800 can be performed by, for example, an EDA tool executing on a computing system. At 810, a printed circuit board layout is accessed from a layout database. At 820, a portion of a signal line of the printed circuit board layout located adjacent to a plurality of pads of the printed circuit board layout arranged in a line from a first pad to a second pad is modified. A centerline extends through the plurality of pads. The modifying the portion of the signal line comprises extending an edge of the signal line that is proximate to the centerline to an edge of a first keep-out region associated with the centerline and to edges of a plurality of second keep-out regions associated with the plurality of pads. At 830, the printed circuit board layout comprising the modified signal line is stored in the layout database.

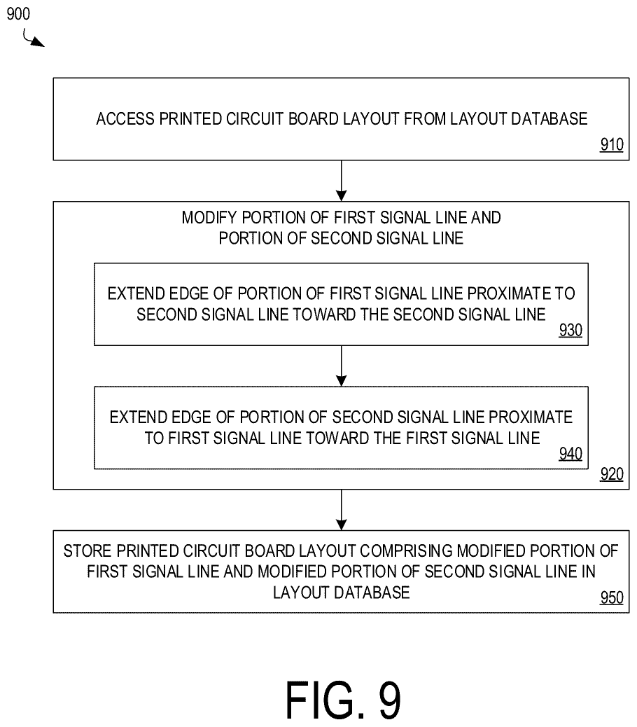

FIG. 9 is a flowchart of a second example method of modifying signal lines in a pin field of a printed circuit board layout. The method 900 can be performed by, for example, an EDA tool executing on a computing system. At 910, a printed circuit board layout is accessed from a layout database. At 920, a portion of a first signal line and a portion of a second signal line of the printed circuit board layout is modified. A plurality of pads of the printed circuit board layout is located between the portion of the first signal line and the portion of the second signal line and arranged in a line from a first pad to a second pad. Modifying the first signal line comprises, at 930, extending a first edge of the portion of the first signal line that is proximate to the portion of the second signal line toward the portion of the second signal line to within a metal-to-metal design rule spacing from the portion of the second signal line and to within a keep-out distance associated with individual pads. Modifying the second signal line comprises, at 940, extending a second edge of the portion of the second signal line that is proximate to the portion of the first signal line toward the portion of the first signal line to within the metal-to-metal design rule spacing from the portion of the first signal line and the keep-out distance from the plurality of pads. At 950, the printed circuit board layout comprising the modified portion of the first signal line and the modified portion of the second signal line is stored in the layout database.

In other embodiments, the methods 800 and 900 can comprise one or more additional elements. For example, the method 800 and/or 900 can further comprise generating a photolithography mask to be used during the manufacture of a printed circuit board comprising the modified signal line. In another example, the method 800 and/or 900 can further comprise manufacturing a printed circuit board comprising the modified signal line.

The technologies described herein provide at least the following advantages. First, the modified signal lines take full advantage of the available signal line muting area in a pin field to lower signal line impedance and improve signal integrity. In a first analysis, a high-frequency structure simulator (HFSS)-based simulation of time domain reflectometry (TDR) impedance of a DDR signal line in a pin field indicates that an unmodified signal line had a TDR impedance of 54.4 ohms, the signal line with tab routing had a TDR impedance of 47 ohms, and the signal line modified according to technologies described herein had a TDR impedance of 40.8 ohms, which is close to the target transmission line impedance for DDR signals of 40 ohms. In a second analysis, modification of signal lines resulted in full-link margin improvement for DDR5 signaling at 5200 Gbps. The simulated eye height for the unmodified signal lines, signal lines with tab muting, and signal lines modified as described herein were 58.4 mV, 66.5 mV, and 77.6 mV, respectively. The simulated eye width for the unmodified signal lines, signal lines with tab muting, and signal lines modified as described herein were 40.6, 50.2, and 51.8 ps, respectively. Thus, the simulation results indicate an improvement of 11.1 mV in eye height and 11.6 ps in eye width resulting from modifying DDR signal lines according to technologies disclosed herein. Second, the automated approach for modifying pin field signal lines allows for a large number of signal lines to be readily modified. Third, the disclosed signal line modification approach can result in modified signal lines that have fewer design rule violations that need to be corrected relative to existing approaches (e.g., tab routing) and allow for faster design rule validation runtimes.

The signal line modification technologies described herein can be performed by or implemented in any of a variety of computing systems, including mobile computing systems (e.g., smartphones, handheld computers, tablet computers, laptop computers, portable gaming consoles, 2-in-1 convertible computers, portable all-in-one computers), non-mobile computing systems (e.g., desktop computers, servers, workstations, stationary gaming consoles, set-top boxes, smart televisions, rack-level computing solutions (e.g., blade, tray, or sled computing systems)), and embedded computing systems (e.g., computing systems that are part of a vehicle, smart home appliance, consumer electronics product or equipment, manufacturing equipment). As used herein, the term “computing system” includes computing devices and includes systems comprising multiple discrete physical components. In some embodiments, the computing systems are located in a data center, such as an enterprise data center (e.g., a data center owned and operated by a company and typically located on company premises), managed services data center (e.g., a data center managed by a third party on behalf of a company), a co-located data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves).

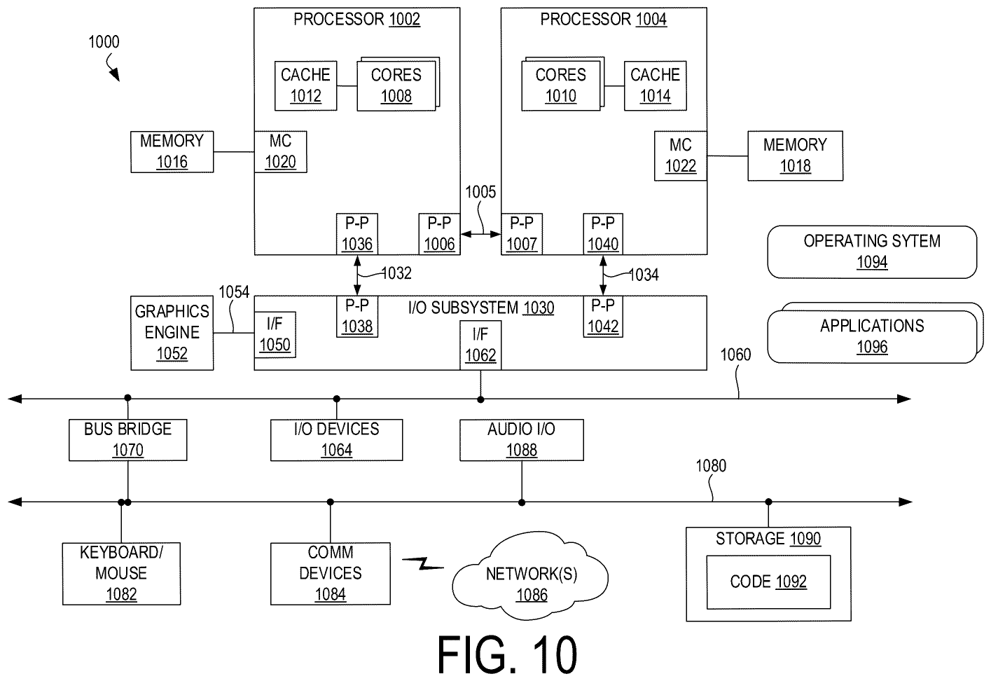

FIG. 10 is a block diagram of an example computing system in which technologies described herein may be implemented. Generally, components shown in FIG. 10 can communicate with other shown components, although not all connections are shown, for ease of illustration. The computing system 1000 is a multiprocessor system comprising a first processor unit 1002 and a second processor unit 1004 comprising point-to-point (P-P) interconnects. A point-to-point (P-P) interface 1006 of the processor unit 1002 is coupled to a point-to-point interface 1007 of the processor unit 1004 via a point-to-point interconnection 1005. It is to be understood that any or all of the point-to-point interconnects illustrated in FIG. 10 can be alternatively implemented as a multi-drop bus, and that any or all buses illustrated in FIG. 10 could be replaced by point-to-point interconnects.

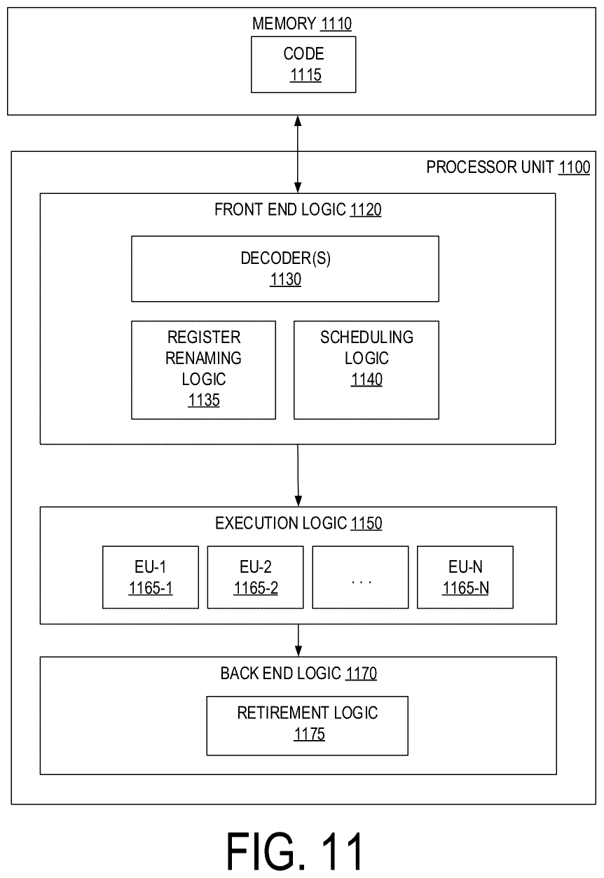

The processor units 1002 and 1004 comprise multiple processor cores. Processor unit 1002 comprises processor cores 1008 and processor unit 1004 comprises processor cores 1010. Processor cores 1008 and 1010 can execute computer-executable instructions in a manner similar to that discussed below in connection with FIG. 11, or other manners.

Processor units 1002 and 1004 further comprise cache memories 1012 and 1014, respectively. The cache memories 1012 and 1014 can store data (e.g., instructions) utilized by one or more components of the processor units 1002 and 1004, such as the processor cores 1008 and 1010. The cache memories 1012 and 1014 can be part of a memory hierarchy for the computing system 1000. For example, the cache memories 1012 can locally store data that is also stored in a memory 1016 to allow for faster access to the data by the processor unit 1002. In some embodiments, the cache memories 1012 and 1014 can comprise multiple cache levels, such as level 1 (L1), level 2 (L2), level 3 (L3), level 4 (L4) and/or other caches or cache levels. In some embodiments, one or more levels of cache memory (e.g., L2, L3, L4) can be shared among multiple cores in a processor unit or among multiple processor units in an integrated circuit component. In some embodiments, the last level of cache memory on an integrated circuit component can be referred to as a last level cache (LLC). One or more of the higher levels of cache levels (the smaller and faster caches) in the memory hierarchy can be located on the same integrated circuit die as a processor core and one or more of the lower cache levels (the larger and slower caches) can be located on an integrated circuit dies that are physically separate from the processor core integrated circuit dies.

Although the computing system 1000 is shown with two processor units, the computing system 1000 can comprise any number of processor units. Further, a processor unit can comprise any number of processor cores. A processor unit can take various forms such as a central processing unit (CPU), a graphics processing unit (GPU), general-purpose GPU (GPGPU), accelerated processing unit (APU), field-programmable gate array (FPGA), neural network processing unit (NPU), data processor unit (DPU), accelerator (e.g., graphics accelerator, digital signal processor (DSP), compression accelerator, artificial intelligence (AI) accelerator), controller, or other types of processing units. As such, the processor unit can be referred to as an XPU (or xPU). Further, a processor unit can comprise one or more of these various types of processing units. In some embodiments, the computing system comprises one processor unit with multiple cores, and in other embodiments, the computing system comprises a single processor unit with a single core. As used herein, the terms “processor unit” and “processing unit” can refer to any processor, processor core, component, module, engine, circuitry, or any other processing element described or referenced herein.

In some embodiments, the computing system 1000 can comprise one or more processor units that are heterogeneous or asymmetric to another processor unit in the computing system. There can be a variety of differences between the processing units in a system in terms of a spectrum of metrics of merit including architectural, microarchitectural, thermal, power consumption characteristics, and the like. These differences can effectively manifest themselves as asymmetry and heterogeneity among the processor units in a system.

The processor units 1002 and 1004 can be located in a single integrated circuit component (such as a multi-chip package (MCP) or multi-chip module (MCM)) or they can be located in separate integrated circuit components. An integrated circuit component comprising one or more processor units can comprise additional components, such as embedded DRAM, stacked high bandwidth memory (HBM), shared cache memories (e.g., L3, L4, LLC), input/output (I/O) controllers, or memory controllers. Any of the additional components can be located on the same integrated circuit die as a processor unit, or on one or more integrated circuit dies separate from the integrated circuit dies comprising the processor units. In some embodiments, these separate integrated circuit dies can be referred to as “chiplets”. In some embodiments where there is heterogeneity or asymmetry among processor units in a computing system, the heterogeneity or asymmetric can be among processor units located in the same integrated circuit component. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Processor units 1002 and 1004 further comprise memory controller logic (MC) 1020 and 1022. As shown in FIG. 10, MCs 1020 and 1022 control memories 1016 and 1018 coupled to the processor units 1002 and 1004, respectively. The memories 1016 and 1018 can comprise various types of volatile memory (e.g., dynamic random-access memory (DRAM), static random-access memory (SRAM)) and/or non-volatile memory (e.g., flash memory, chalcogenide-based phase-change non-volatile memories), and comprise one or more layers of the memory hierarchy of the computing system. While MCs 1020 and 1022 are illustrated as being integrated into the processor units 1002 and 1004, in alternative embodiments, the MCs can be external to a processor unit.

Processor units 1002 and 1004 are coupled to an Input/Output (I/O) subsystem 1030 via point-to-point interconnections 1032 and 1034. The point-to-point interconnection 1032 connects a point-to-point interface 1036 of the processor unit 1002 with a point-to-point interface 1038 of the I/O subsystem 1030, and the point-to-point interconnection 1034 connects a point-to-point interface 1040 of the processor unit 1004 with a point-to-point interface 1042 of the I/O subsystem 1030. Input/Output subsystem 1030 further includes an interface 1050 to couple the I/O subsystem 1030 to a graphics engine 1052. The I/O subsystem 1030 and the graphics engine 1052 are coupled via a bus 1054.

The Input/Output subsystem 1030 is further coupled to a first bus 1060 via an interface 1062. The first bus 1060 can be a Peripheral Component Interconnect Express (PCIe) bus or any other type of bus. Various I/O devices 1064 can be coupled to the first bus 1060. A bus bridge 1070 can couple the first bus 1060 to a second bus 1080. In some embodiments, the second bus 1080 can be a low pin count (LPC) bus. Various devices can be coupled to the second bus 1080 including, for example, a keyboard/mouse 1082, audio I/O devices 1088, and a storage device 1090, such as a hard disk drive, solid-state drive, or another storage device for storing computer-executable instructions (code) 1092 or data. The code 1092 can comprise computer-executable instructions for performing methods described herein. Additional components that can be coupled to the second bus 1080 include communication device(s) 1084, which can provide for communication between the computing system 1000 and one or more wired or wireless networks 1086 (e.g. Wi-Fi, cellular, or satellite networks) via one or more wired or wireless communication links (e.g., wire, cable, Ethernet connection, radio-frequency (RF) channel, infrared channel, Wi-Fi channel) using one or more communication standards (e.g., IEEE 1002.11 standard and its supplements).

In embodiments where the communication devices 1084 support wireless communication, the communication devices 1084 can comprise wireless communication components coupled to one or more antennas to support communication between the computing system 1000 and external devices. The wireless communication components can support various wireless communication protocols and technologies such as Near Field Communication (NFC), IEEE 1002.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM), and 5G broadband cellular technologies. In addition, the wireless modems can support communication with one or more cellular networks for data and voice communications within a single cellular network, between cellular networks, or between the computing system and a public switched telephone network (PSTN).

The system 1000 can comprise removable memory such as flash memory cards (e.g., SD (Secure Digital) cards), memory sticks, Subscriber Identity Module (SIM) cards). The memory in system 1000 (including caches 1012 and 1014, memories 1016 and 1018, and storage device 1090) can store data and/or computer-executable instructions for executing an operating system 1094 and application programs 1096. Example data includes web pages, text messages, images, sound files, video data, and printed circuit board layouts to be sent to and/or received from one or more network servers or other devices by the system 1000 via the one or more wired or wireless networks 1086, or for use by the system 1000. The system 1000 can also have access to external memory or storage (not shown) such as external hard drives or cloud-based storage.

The operating system 1094 can control the allocation and usage of the components illustrated in FIG. 10 and support the one or more application programs 1096. The application programs 1096 can include common computing system applications (e.g., email applications, calendars, contact managers, web browsers, messaging applications) as well as other computing applications, such as EDA tools.

In some embodiments, a hypervisor (or virtual machine manager) operates on the operating system 1094 and the application programs 1096 operate within one or more virtual machines operating on the hypervisor. In these embodiments, the hypervisor is a type-2 or hosted hypervisor as it is running on the operating system 1094. In other hypervisor-based embodiments, the hypervisor is a type-1 or “bare-metal” hypervisor that runs directly on the platform resources of the computing system 1094 without an intervening operating system layer.

In some embodiments, the applications 1096 can operate within one or more containers. A container is a running instance of a container image, which is a package of binary images for one or more of the applications 1096 and any libraries, configuration settings, and any other information that one or more applications 1096 need for execution. A container image can conform to any container image format, such as Docker®, Appc, or LXC container image formats. In container-based embodiments, a container runtime engine, such as Docker Engine, LXU, or an open container initiative (OCI)-compatible container runtime (e.g., Railcar, CRI-O) operates on the operating system (or virtual machine monitor) to provide an interface between the containers and the operating system 1094. An orchestrator can be responsible for management of the computing system 1000 and various container-related tasks such as deploying container images to the computing system 1094, monitoring the performance of deployed containers, and monitoring the utilization of the resources of the computing system 1094.

The computing system 1000 can support various additional input devices, such as a touchscreen, microphone, monoscopic camera, stereoscopic camera, trackball, touchpad, trackpad, proximity sensor, light sensor, electrocardiogram (ECG) sensor, PPG (photoplethysmogram) sensor, galvanic skin response sensor, and one or more output devices, such as one or more speakers or displays. Other possible input and output devices include piezoelectric and other haptic I/O devices. Any of the input or output devices can be internal to, external to, or removably attachable with the system 1000. External input and output devices can communicate with the system 1000 via wired or wireless connections.

The system 1000 can further include at least one input/output port comprising physical connectors (e.g., USB, IEEE 1394 (FireWire), Ethernet, RS-232), a power supply (e.g., battery), a global satellite navigation system (GNSS) receiver (e.g., GPS receiver); a gyroscope; an accelerometer, and/or a compass. A GNSS receiver can be coupled to a GNSS antenna. The computing system 1000 can further comprise one or more additional antennas coupled to one or more additional receivers, transmitters, and/or transceivers to enable additional functions.

In addition to those already discussed, integrated circuit components, integrated circuit constituent components, and other components in the computing system 1094 can communicate with interconnect technologies such as Intel® QuickPath Interconnect (QPI), Intel® Ultra Path Interconnect (UPI), Computer Express Link (CXL), cache coherent interconnect for accelerators (CCIX®), serializer/deserializer (SERDES), Nvidia® NVLink, ARM Infinity Link, Gen-Z, or Open Coherent Accelerator Processor Interface (OpenCAPI). Other interconnect technologies may be used and a computing system 1094 may utilize more or more interconnect technologies.

It is to be understood that FIG. 10 illustrates only one example computing system architecture. Computing systems based on alternative architectures can be used to implement technologies described herein. For example, instead of the processors 1002 and 1004 and the graphics engine 1052 being located on discrete integrated circuits, a computing system can comprise an SoC (system-on-a-chip) integrated circuit incorporating multiple processors, a graphics engine, and additional components. Further, a computing system can connect its constituent component via bus or point-to-point configurations different from that shown in FIG. 10. Moreover, the illustrated components in FIG. 10 are not required or all-inclusive, as shown components can be removed and other components added in alternative embodiments.

FIG. 11 is a block diagram of an example processor unit 1100 to execute computer-executable instructions as part of implementing technologies described herein. The processor unit 1100 can be a single-threaded core or a multithreaded core in that it may include more than one hardware thread context (or “logical processor”) per processor unit.

FIG. 11 also illustrates a memory 1110 coupled to the processor unit 1100. The memory 1110 can be any memory described herein or any other memory known to those of skill in the art. The memory 1110 can store computer-executable instructions 1115 (code) executable by the processor core 1100.

The processor unit comprises front-end logic 1120 that receives instructions from the memory 1110. An instruction can be processed by one or more decoders 1130. The decoder 1130 can generate as its output a micro-operation such as a fixed width micro operation in a predefined format, or generate other instructions, microinstructions, or control signals, which reflect the original code instruction. The front-end logic 1120 further comprises register renaming logic 1135 and scheduling logic 1140, which generally allocate resources and queues operations corresponding to converting an instruction for execution.

The processor unit 1100 further comprises execution logic 1150, which comprises one or more execution units (EUs) 1165-1 through 1165-N. Some processor unit embodiments can include a number of execution units dedicated to specific functions or sets of functions. Other embodiments can include only one execution unit or one execution unit that can perform a particular function. The execution logic 1150 performs the operations specified by code instructions. After completion of execution of the operations specified by the code instructions, back-end logic 1170 retires instructions using retirement logic 1175. In some embodiments, the processor unit 1100 allows out of order execution but requires in-order retirement of instructions. Retirement logic 1175 can take a variety of forms as known to those of skill in the art (e.g., re-order buffers or the like).

The processor unit 1100 is transformed during execution of instructions, at least in terms of the output generated by the decoder 1130, hardware registers and tables utilized by the register renaming logic 1135, and any registers (not shown) modified by the execution logic 1150.

As used herein, the term “module” refers to logic that may be implemented in a hardware component or device, software or firmware running on a processor unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processor units, state machine circuitry, and/or firmware that stores instructions executable by programmable circuitry. Modules described herein may, collectively or individually, be embodied as circuitry that forms a part of a computing system. Thus, any of the modules can be implemented as circuitry, such as signal line modification circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processor units capable of executing computer-executable instructions to perform any of the disclosed methods. As used herein, the term “computer” refers to any computing system, device, or machine described or mentioned herein as well as any other computing system, device, or machine capable of executing instructions. Thus, the term “computer-executable instruction” refers to instructions that can be executed by any computing system, device, or machine described or mentioned herein as well as any other computing system, device, or machine capable of executing instructions.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some embodiments, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

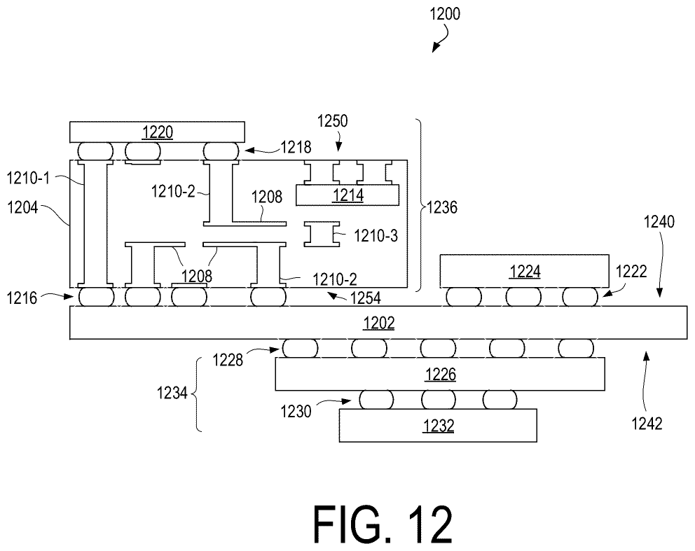

FIG. 12 is a cross-sectional side view of an integrated circuit device assembly that may include a printed circuit board manufactured based on a printed circuit board layout modified as disclosed herein. The integrated circuit device assembly 1200 includes a number of components disposed on a circuit board 1202 (which may be a motherboard, system board, mainboard, etc.), which may be a printed circuit board manufactured based on a printed circuit board layout modified as disclosed herein. The integrated circuit device assembly 1200 includes components disposed on a first face 1240 of the circuit board 1202 and an opposing second face 1242 of the circuit board 1202; generally, components may be disposed on one or both faces 1240 and 1242.

In some embodiments, the circuit board 1202 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1202. In other embodiments, the circuit board 1202 may be a non-PCB substrate. The integrated circuit device assembly 1200 illustrated in FIG. 12 includes a package-on-interposer structure 1236 coupled to the first face 1240 of the circuit board 1202 by coupling components 1216. The coupling components 1216 may electrically and mechanically couple the package-on-interposer structure 1236 to the circuit board 1202, and may include solder balls (as shown in FIG. 12), pins (e.g., as part of a pin grid array (PGA), contacts (e.g., as part of a land grid array (LGA)), male and female portions of a socket, an adhesive, an underfill material, and/or any other suitable electrical and/or mechanical coupling structure. The coupling components 1216 may serve as the coupling components illustrated or described for any of the substrate assembly or substrate assembly components described herein, as appropriate.

The package-on-interposer structure 1236 may include an integrated circuit component 1220 coupled to an interposer 1204 by coupling components 1218. The coupling components 1218 may take any suitable form for the application, such as the forms discussed above with reference to the coupling components 1216. Although a single integrated circuit component 1220 is shown in FIG. 12, multiple integrated circuit components may be coupled to the interposer 1204; indeed, additional interposers may be coupled to the interposer 1204. The interposer 1204 may provide an intervening substrate used to bridge the circuit board 1202 and the integrated circuit component 1220.

The integrated circuit component 1220 may be a packaged or unpacked integrated circuit product that includes one or more integrated circuit dies and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1220, a single monolithic integrated circuit die comprises solder bumps attached to contacts on the die. The solder bumps allow the die to be directly attached to the interposer 1204. The integrated circuit component 1220 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1220 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1220 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1220 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1204 may spread connections to a wider pitch or reroute a connection to a different connection. For example, the interposer 1204 may couple the integrated circuit component 1220 to a set of ball grid array (BGA) conductive contacts of the coupling components 1216 for coupling to the circuit board 1202. In the embodiment illustrated in FIG. 12, the integrated circuit component 1220 and the circuit board 1202 are attached to opposing sides of the interposer 1204; in other embodiments, the integrated circuit component 1220 and the circuit board 1202 may be attached to a same side of the interposer 1204. In some embodiments, three or more components may be interconnected by way of the interposer 1204.

In some embodiments, the interposer 1204 may be formed as a printed circuit board, including multiple metal layers separated from one another by layers of dielectric material and interconnected by electrically conductive vias. In some embodiments, the interposer 1204 may be formed of an epoxy resin, a fiberglass-reinforced epoxy resin, an epoxy resin with inorganic fillers, a ceramic material, or a polymer material such as polyimide. In some embodiments, the interposer 1204 may be formed of alternate rigid or flexible materials that may include the same materials described above for use in a semiconductor substrate, such as silicon, germanium, and other group III-V and group IV materials. The interposer 1204 may include metal interconnects 1208 and vias 1210, including but not limited to through hole vias 1210-1 (that extend from a first face 1250 of the interposer 1204 to a second face 1254 of the interposer 1204), blind vias 1210-2 (that extend from the first or second faces 1250 or 1254 of the interposer 1204 to an internal metal layer), and buried vias 1210-3 (that connect internal metal layers).

In some embodiments, the interposer 1204 can comprise a silicon interposer. Through silicon vias (TSV) extending through the silicon interposer can connect connections on a first face of a silicon interposer to an opposing second face of the silicon interposer. In some embodiments, an interposer 1204 comprising a silicon interposer can further comprise one or more routing layers to route connections on a first face of the interposer 1204 to an opposing second face of the interposer 1204.

The interposer 1204 may further include embedded devices 1214, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1204. The package-on-interposer structure 1236 may take the form of any of the package-on-interposer structures known in the art. In embodiments where the interposer is a non-printed circuit board

The integrated circuit device assembly 1200 may include an integrated circuit component 1224 coupled to the first face 1240 of the circuit board 1202 by coupling components 1222. The coupling components 1222 may take the form of any of the embodiments discussed above with reference to the coupling components 1216, and the integrated circuit component 1224 may take the form of any of the embodiments discussed above with reference to the integrated circuit component 1220.

The integrated circuit device assembly 1200 illustrated in FIG. 12 includes a package-on-package structure 1234 coupled to the second face 1242 of the circuit board 1202 by coupling components 1228. The package-on-package structure 1234 may include an integrated circuit component 1226 and an integrated circuit component 1232 coupled together by coupling components 1230 such that the integrated circuit component 1226 is disposed between the circuit board 1202 and the integrated circuit component 1232. The coupling components 1228 and 1230 may take the form of any of the embodiments of the coupling components 1216 discussed above, and the integrated circuit components 1226 and 1232 may take the form of any of the embodiments of the integrated circuit component 1220 discussed above. The package-on-package structure 1234 may be configured in accordance with any of the package-on-package structures known in the art.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

The following examples pertain to additional embodiments of technologies disclosed herein.

Example 1 is a printed circuit board comprising a signal line located adjacent to a plurality of pads, the plurality of pads arranged in a line from a first pad to a second pad, the signal line substantially filling an area bounded by a first centerline extending through the plurality of the pads, a second centerline of the first pad, a second centerline of the second pad, and a first edge of the signal line that is a distal edge of the signal line relative to the first centerline, wherein the second centerline of the first pad and the second centerline of the second pad are orthogonal to the first centerline, the signal line substantially filling the area to an extent that it is spaced from the pads, a shape of a portion of an edge of the signal line in a vicinity of an individual pad substantially identical to a shape of a portion of the edge of the individual pad in a vicinity of the signal line.

Example 2 comprises the printed circuit board of Example 1, wherein the plurality of pads are located within a pin field.

Example 3 is a printed circuit board comprising a signal line adjacent to a plurality of vias, the plurality of vias arranged in a line from a first via to a second via, the signal line substantially filling an area bounded by a first centerline extending through the plurality of the vias, a second centerline of the first via, a second centerline of the second via, and a first edge of the first signal line that is a distal edge of the signal line relative to the first centerline, wherein the second centerline of the first via and the second centerline of the second via are orthogonal to the first centerline, the signal line substantially filling the area to an extent that it is spaced from the vias, a shape of a portion of an edge of the signal line in a vicinity of an individual via is substantially identical to a shape of a portion of an edge of the individual via in a vicinity of the signal line.

Example 4 comprises the printed circuit board of any one of Examples 1-3, the signal line substantially filling the area to a further extent that it is spaced from one or more additional signal lines.

Example 5 comprises the printed circuit board of any one of Examples 1-4, wherein one or more integrated circuit components are attached or connected to the printed circuit board.

Example 6 comprises the printed circuit board of Example 5, wherein the one or more integrated circuit components a processing unit and/or a memory.

Example 7 is a method comprising: accessing a printed circuit board layout from a layout database; modifying a portion of a signal line of the printed circuit board layout located adjacent to a plurality of pads of the printed circuit board layout arranged in a line from a first pad to a second pad, a centerline extending through the plurality of pads, the modifying the portion of the signal line comprising extending an edge of the signal line that is proximate to the centerline to an edge of a first keep-out region associated with the centerline and to edges of a plurality of second keep-out regions associated with the plurality of pads; and storing the printed circuit board layout comprising the modified signal line in the layout database.

Example 8 comprises the method of Example 7, wherein an extent of the first keep-out region is based on a metal-to-metal design rule spacing.

Example 9 comprises the method of Example 7 or 8, wherein individual of the second keep-out regions extend from a via associated with individual of the pads and an extent of the individual second keep-out regions is based on a via-to-metal design rule spacing.

Example 10 comprises the method of Example 7 or 8, wherein individual of the second keep-out regions extend from one of the pads and an extent of the individual second keep-out regions is a metal-to-metal design rule spacing.

Example 11 comprises the method of any one of Examples 7-10, the extending the edge of the signal line that is proximate to the centerline to the edge of the first keep-out region associated with the centerline and to the edges of the plurality of the second keep-out regions associated with the plurality of pads comprising: extending the edge of the signal line that is proximate to the centerline past the edge of the first keep-out region and past the edges of the plurality of the second keep-out regions; and pulling the edge of the signal line that is proximate to the centerline back to the edge of the first keep-out region and to the edges of the plurality of the second keep-out regions.

Example 12 comprises the method of any one of Examples 7-10, the extending the edge of the signal line that is proximate to the centerline to the edge of the first keep-out region associated with the centerline and to the edges of the plurality of the second keep-out regions associated with the plurality of pads comprising: extending the edge of the signal line that is proximate to the centerline to the centerline; extending the edge of the signal line that is proximate to the centerline to pad edges of the plurality of pads; and pulling the edge of the signal line that is proximate to the centerline back to the edge of the first keep-out region and to the edges of the plurality of the second keep-out regions.

Example 13 comprises the method of any one of Examples 7-12, wherein the modified signal line is represented in the printed circuit board layout stored in the layout database as a single shape.

Example 14 comprises the method of any one of Examples 7-13, wherein the portion of the signal line is located within a pin field of the printed circuit board layout.

Example 15 comprises the method of any one of Examples 7-14, wherein the centerline extending through the pads is a first centerline, the portion of the signal line is located between a second centerline associated with the first pad and a second centerline associated with the second pad, the second centerline associated with the first pad and the second centerline associated with the second pad being orthogonal to the first centerline.

Example 16 is a method comprising: accessing a printed circuit board layout from a layout database; modifying a portion of a first signal line and a portion of a second signal line of the printed circuit board layout, a plurality of pads of the printed circuit board layout located between the portion of the first signal line and the portion of the second signal line and arranged in a line from a first pad to an second pad, the modifying the portion of the first signal line comprising extending a first edge of the portion of the first signal line that is proximate to the portion of the second signal line toward the portion of the second signal line to within a metal-to-metal design rule spacing from the portion of the second signal line and to within a keep-out distance associated with individual of the pads, the modifying the portion of the second signal line comprising extending a second edge of the portion of the second signal line that is proximate to the portion of the first signal line toward the portion of the first signal line to within the metal-to-metal design rule spacing from the portion of the first signal line and the keep-out distance associated with individual of the pads; and storing the printed circuit board layout comprising the modified portion of the first signal line and the modified portion of the second signal line in the layout database.

Example 17 comprises the method of Example 16, wherein extending the first edge of the portion of the first signal line to within a keep-out distance associated with individual of the plurality of pads comprises extending the first edge of the portion of the first signal line to within a metal-to-metal design rule spacing of the individual pad and extending the second edge of the portion of the second signal line to within a keep-out distance associated with individual of the plurality of pads comprising extending the second edge of the portion of the second signal line to within a metal-to-metal design rule spacing of the individual pad.

Example 18 comprises the method of Example 16, wherein extending the first edge of the portion of the first signal line to within a keep-out distance associated with individual of the plurality of pads comprises extending the first edge of the portion of the first signal line to within a via-to-metal design rule spacing of a via associated with the individual pad and extending the second edge of the portion of the second signal line to within a keep-out distance associated with individual of the plurality of pads comprises extending the second edge of the portion of the second signal line to within a via-to-metal design rule spacing of a via associated with the individual pad.

Example 19 comprises the method of any one of Examples 7-18, further comprising generating a photolithography mask to be used during manufacture of a printed circuit board comprising the modified portion of the signal line.

Example 20 comprises the method of any one of Examples 7-19, further comprising manufacturing a printed circuit board comprising the modified portion of the signal line.

Example 21 is one or more computer-readable storage media storing computer-executable instructions that, when executed, cause a computing system to perform any one of the methods of Examples 7-19.

Example 22 is a computing system comprising: one or more processing units; and one or more memories storing a printed circuit board layout and computer-executable instructions that, when executed, cause the one or more processing units to perform any one of the methods of Examples 7-19.

Example 23 is an apparatus comprising a means to perform any one of the methods of Examples 7-19.

Example 24 comprises the method of any one of Examples 8-10 and 17-19 wherein the metal-to-metal design rule spacing or the via-to-metal design rule spacing is set by a design for manufacturing rule.

Example 25 comprises the method of any one of Examples 8-10 and 17-19 wherein the metal-to-metal design rule spacing or the via-to-metal design rule spacing is set by a signal integrity performance requirement.

1-25. (canceled)

26. A printed circuit board comprising a signal line located adjacent to a plurality of pads, the plurality of pads arranged in a line from a first pad to a second pad, the signal line substantially filling an area bounded by a first centerline extending through the plurality of pads, a second centerline of the first pad, a second centerline of the second pad, and a first edge of the signal line that is a distal edge of the signal line relative to the first centerline, wherein the second centerline of the first pad and the second centerline of the second pad are orthogonal to the first centerline, the signal line substantially filling the area to an extent that it is spaced from the plurality of pads, a shape of a portion of an edge of the signal line in a vicinity of an individual pad substantially identical to a shape of a portion of the edge of the individual pad in a vicinity of the signal line.

27. The printed circuit board of claim 26, wherein the plurality of pads are located within a pin field.

28. The printed circuit board of claim 26, the signal line substantially filling the area to a further extent that it is spaced from one or more additional signal lines.

29. The printed circuit board of claim 26, wherein one or more integrated circuit components are attached or connected to the printed circuit board.

30. The printed circuit board of claim 29, wherein the one or more integrated circuit components a processing unit and/or a memory.

31. A method comprising:
accessing a printed circuit board layout from a layout database;
modifying a portion of a signal line of the printed circuit board layout located adjacent to a plurality of pads of the printed circuit board layout arranged in a line from a first pad to a second pad, a centerline extending through the plurality of pads, modifying the portion of the signal line comprising extending an edge of the signal line that is proximate to the centerline to an edge of a first keep-out region associated with the centerline and to edges of a plurality of second keep-out regions associated with the plurality of pads; and
storing the printed circuit board layout comprising the modified signal line in the layout database.

32. The method of claim 31, wherein an extent of the first keep-out region is based on a metal-to-metal design rule spacing.

33. The method of claim 32, wherein individual of the plurality of second keep-out regions extend from a via associated with individual of the plurality of pads and an extent of the individual of the plurality of second keep-out regions is based on a via-to-metal design rule spacing.

34. The method of claim 32, wherein individual of the plurality of second keep-out regions extend from one of the plurality of pads and an extent of the individual of the plurality of second keep-out regions is a metal-to-metal design rule spacing.

35. The method of claim 32, wherein the centerline extending through the plurality of pads is a first centerline, the portion of the signal line is located between a second centerline associated with the first pad and a second centerline associated with the second pad, the second centerline associated with the first pad and the second centerline associated with the second pad being orthogonal to the first centerline.

36. The method of claim 32, further comprising generating a photolithography mask to be used during manufacture of a printed circuit board comprising the modified portion of the signal line.

37. The method of claim 32, further comprising manufacturing a printed circuit board comprising the modified portion of the signal line.

38. One or more computer-readable storage media storing computer-executable instructions that, when executed, cause a computing system to:
access a printed circuit board layout from a layout database;
modify a portion of a signal line of the printed circuit board layout located adjacent to a plurality of pads of the printed circuit board layout arranged in a line from a first pad to a second pad, a centerline extending through the plurality of pads, to modify the portion of the signal line comprising to extend an edge of the signal line that is proximate to the centerline to an edge of a first keep-out region associated with the centerline and to edges of a plurality of second keep-out regions associated with the plurality of pads; and
store the printed circuit board layout comprising the modified signal line in the layout database.

39. The one or more computer-readable storage media of claim 38, wherein an extent of the first keep-out region is based on a metal-to-metal design rule spacing.

40. The one or more computer-readable storage media of claim 39, wherein the metal-to-metal design rule spacing is set by a signal integrity performance requirement.

41. The one or more computer-readable storage media of claim 38, wherein individual of the plurality of second keep-out regions extend from a via associated with individual of the plurality of pads and an extent of the individual of the plurality of second keep-out regions is based on a via-to-metal design rule spacing.

42. The one or more computer-readable storage media of claim 38, wherein individual of the plurality of second keep-out regions extend from one of the plurality of pads and an extent of the individual of plurality of second keep-out regions is a metal-to-metal design rule spacing.

43. The one or more computer-readable storage media of claim 38, wherein the modified signal line is represented in the printed circuit board layout stored in the layout database as a single shape.

44. The one or more computer-readable storage media of claim 38, wherein the centerline extending through the plurality of pads is a first centerline, the portion of the signal line is located between a second centerline associated with the first pad and a second centerline associated with the second pad, the second centerline associated with the first pad and the second centerline associated with the second pad being orthogonal to the first centerline.

45. The one or more computer-readable storage media of claim 38, wherein to extend the edge of the signal line that is proximate to the centerline to the edge of the first keep-out region associated with the centerline and to the edges of the plurality of second keep-out regions associated with the plurality of pads comprises:
extending the edge of the signal line that is proximate to the centerline to the centerline;
extending the edge of the signal line that is proximate to the centerline to pad edges of the plurality of pads; and
pulling the edge of the signal line that is proximate to the centerline back to the edge of the first keep-out region and to the edges of the plurality of second keep-out regions.
